(19) United States
(12) Patent Application Publication
(10) Pub. No.: US 2007/0262003 A1
(43) Pub. Date: Nov. 15, 2007

(54) METHOD TO OPERATE A FLUSHABLE FILTER COLUMN FOR A LIQUID

(75) Inventor: Willi Kussel, Werne (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tiefenbach Control System GmbH

(21) Appl. No.: 11/747,586

(22) Filed: May 11, 2007

Related U.S. Application Data
(63) Continuation of application No. PCT/DE05/02012, filed on Nov. 9, 2005.

(30) Foreign Application Priority Data
Nov. 12, 2004 (DE) 10 2004 054 884.6

(51) Int. Cl. B01D 35/00

(52) U.S. Cl. 210/106

(57) ABSTRACT

The present invention provides a method of operating a flushable filter column for a liquid. During the operation of a filter column, comprising several filter units, for a liquid, the filter units are flown through by the liquid in a forward direction in a filtering flow in the sense of filtering and in a flushing flow in reverse in the sense of reverse flushing. For each group of filter units, that can be blocked and reverse flushed together, a control valve, actuatable by its own electromagnet, is provided. The control valves are triggered in such a manner by an electronic control device depending on a state or operational parameter, which represent the degree of soiling of the filter unit, that the groups can be opened to the filtering flow or switched for blocking and reverse flushing. The reverse flushing is carried out in a flushing cycle, i.e. all filter units of the filter column are reverse flushed after one another, in succession.

### CROSS REFERENCE TO RELATED APPLICATION

The present application is a continuation of international application PCT/DE 2005/002012, filed Nov. 9, 2005, and which designates the U.S. The disclosure of the referenced application is incorporated herein by reference.

### BACKGROUND OF THE INVENTION

The invention relates to a method to operate a flushable filter column comprising several filter units for a liquid. Filter columns are used for the cleaning of a liquid, be it for consumption or hydraulic fluid for a hydraulic plant. The filter column has to be, as far as possible, always available, especially in the latter case of application. The filter columns are constructed from two or more filter units, whereby one or several filter units are temporarily closed to the regular flow of liquid (filtering flow) and then can be flown through in the reverse direction (flushing flow), backwashed and cleaned. Particular requirements are placed on this type of filter columns and their operation in the mining industry, where in the case of a longwall coal mining a large number of hydraulic reversing cylinders and holding cylinders are operated by one pump and a filter column comprising at very high pressures of 350 bar, with very large hydraulic throughputs, water or aqueous emulsion is used as hydraulic fluid, and generally the safety requirements are very high.

A particular reason for the breakdown of the filter column in such plants is that due to soiling such high pressure differentials occur in the individual filter units, that the filters, generally cylindrical filter cartridges and/or the porous cylindrical support bodies, surrounding and supporting them, will collapse. To prevent this, hydraulic plants with filter columns, comprising two or more filter units or groups of filter units are used in the mining industry, which from time to time are so connected with the main flow (pressurised flow, filtering flow) by a manually operated hydraulic valve coming from the filter, that only a portion of the filter units of the pressurised line are flown through in the direction of the main flow in the sense of the filtering, the remaining filter units are flown through in the sense of reverse flushing (flushing flow) in reverse to the main flow. It can be seen, that in this case the operational capability of the hydraulic plant depends on the fact whether the switching over of the hydraulic valve to reverse flushing is carried out sufficiently often and regularly and often for all filter units of the filter column. This, however, is difficult to ensure with a manually operated valve.

From DE 01 229A a filter system with two filters is known, that are connected to a common pre-chamber 1 and basically operate simultaneously. In accordance with the measured result the pressure differential switch 11, 12 switches over each filter to reverse flushing, if required. For this purpose via the control block 15 the blocking valves 22, 23 are closed, the directional control valves 26, 27 are switched over, the blocking valve 18, 19 are opened. The reverse flushing is carried out via a pressure converter 7, 8 or 32, 33.

U.S. Pat. No. 4,636,306 A=DE 35 26 293 A1 shows a filter system to be used in the mining industry. Two filters 5, 6 are alternately flown through or flushed. The switching over is carried out by monitoring the pressure drop on dash-pot devices 34, 35.

GB 2 066 688 A=DE 3100016 A1 shows an immersion pump with two filters in the suction line 48. The filters are operated alternately via suction distribution stages, but also together. Provision is also made that both filters are open in the filtering direction when one is already blocked (GB lines 60-64). Therefore not both filters are available for filtering, what reduces the capacity. The control is carried out as a function of the magnitude of the vacuum in the suction line 44, 46.

These executions have the disadvantage, that the filter system will be operated until at least one of the filters reaches the limit value for soiling. However, one has to reckon with that in this case the other filter has also reached a degree of soiling that impairs the capacity.

An object of the invention is so to operate a filter column of this type with a plurality of filter units, that it can be operated over a long period at a high pressure with great reliability and with a non-diminishing throughput.

This object and others are achieved by providing a method to operate a flushable filter column including several filter units for a liquid, comprising conveying the liquid to be filtered through the filter units in a forward direction in a filtering flow and, depending on the state or operational parameters of the filter units, which represent the state of soiling of the filter units recorded by a measuring instrument, conveying the liquid through the individual filter units in reverse in a reverse flushing flow, wherein depending on the state or operational parameter recorded by the measuring instrument, a flushing cycle is started wherein each filter unit is blocked and reverse flushed in succession.

At least two groups of filter units belong to the filter column. Each group has at least one filter unit. Each filter unit has a housing with inlet and outlet for the filtering flow. The inlet is connected to a pressurised line to convey the hydraulic flow via a controllable and blockable control valve. If several filter units comprise a group, the pressurised line branches off prior to the connection with the respective inlet of the individual filter units and the filter units, part of the group, are controlled via a common control valve, situated before the branching off. The outlets of all filter units of the filter column are connected to a consumer line, which can branch off to a plurality of consumers. By means of the control valve each filter unit or a group of filter units can be blocked and reverse flushed, while the filtering flow keeps flowing through the other filter units of the filter column. Within the scope of this application everything that is stated regarding a single filter unit, also applies for such a group that can be blocked and reverse flushed separately and independently from the other filter units.

The solution has at least the following advantages:
the filter column may comprise more than two filter units, each of which can be blocked from the main flow and reverse flushed,
when using more than two filter units in the filter column the throughput of the filter column (quantity per unit of time) is less impaired than in the case when only two filter units comprise a filter column,
when the filter column has more than two filter units, the blocking of only one filter unit in a filter column of more than two filter units leads to a lesser pressure increase before the filter unit and to a smaller pressure difference (before and after the filter unit),
the use of the electronic control allows a plurality of modi operandi with automation, while these modi operandi can be adapted to suit the soil load, the capacitance of the filters, the respective throughputs and the safety standard of the plant,
the cleaning of the filter unit is carried out not only when required, i.e. when a maximum permissible soiling of a filter is exceeded, but cyclically. In a cleaning or flushing cycle all filter units can be blocked and reverse flushed in succession or in turn without interrupting the operation of the hydraulic plant.

In another embodiment, a state or operational parameter recorded by the measuring instrument is the filtering operating time of the filter units, wherein a specification of a filtering operating time of the filter units is stored in a memory, and wherein when the specified filtering operating time expires the flushing cycle is started. This embodiment provides definitive operational parameters for the filtering period (operating period in the filtering flow) for the filter units. This solution is simple as far as plant technology is concerned and sturdy and can be set to any position as far as the operation is concerned and can be adapted to suit the operating conditions. In the case of this execution the electronic control comprises a time control, that makes the input of the allowable operating period for each of the switchable filter unit or groups of filter units possible, fixes the time of the commencement of the operation after each reverse flushing and reversal to the main flow, carries out the measuring of the time from the commencement of the operation, and by comparing the expired operating time with the specified one prompts the start of the new flushing cycle.

The specification of the allowable operating period is carried out in this case in accordance with values obtained by experience during the progression of another condition or operational parameter (e.g. loss of pressure or pressure differential on the filters or between inlet and outlet of the filter housing or of the filter column), that represents the degree of soiling of the filter units or filter column and when taking the operating conditions and safety requirements into consideration within the operating period, specified as allowable, must not be exceeded or fall short, when the operational capability of a portion of the filter units of the filter column has to be ensured during the flushing operation of another portion also to maintain the continuous operation of the entire filter column.

In another embodiment, a state or operational parameter recorded by the measuring instrument is the pressure before or after the filter column, wherein at least one of a specified upper pressure limit before the filter column or a lower pressure limit after the filter column is stored in a memory, and wherein the flushing cycle is started when the specified upper pressure limit is exceeded or the pressure drops below the specified lower pressure limit. The mode of operation according to this embodiment allows with a little effort of measuring a close adaptation of the filtering operation of the filter column to suit the operation of the hydraulic plant. It is essentially based on the fact, that depending on the operating conditions of the hydraulic plant before the filter unit and also after the filter unit a certain operating range of the hydraulic pressure is established. When this expected operating range is abandoned, the filter units are blocked and reverse flushed in succession or in groups. The measuring of the pressure before and/or after the filter column provides sufficient information about the state as well as the mechanical load of the individual filter units.

It needs to be emphasised, that a time control in accordance with one embodiment of the present invention can be used also in conjunction with a pressure control in accordance with another embodiment or pressure differential control in accordance with still another embodiment. In this case the time control can serve for a regular reverse flushing at specified time intervals, in which normally one cannot expect high pressures or high pressure differentials. The switching over to reverse flushing by pressure control or pressure differential control is carried out only when the pressure or pressure differential values exceed inadmissible limits.

The reverse operation is also possible: the switching over of the filter unit to reverse flushing is carried out basically when exceeding specified limit values for pressure or pressure differential; on the other hand the time intervals for the overlapping time control are so calculated, that in normal operation the time control intervenes not only when the hydraulic plant is operated for a longer period at low pressures and/or small throughputs and for this reason the specified pressure or pressure differential limits are not exceeded.

Developments of the invention provide pressure sensors as measuring equipment. At the same time such solutions, which monitor the entire filter column via a measuring instrument, have the advantage that the measuring effort will be reduced. This is particularly valid for measuring the pressure according to claims 3 and 4. These have the advantage, that the pressure of the total hydraulic flow of the filter column is not only indication regarding the state of the hydraulic medium, but also about each filter unit and particularly also a magnitude indicating the mechanical load capacity of the filter units, which should be monitored for purposes of safety.

In particular the development according to various embodiments has the advantage that the blocking and reverse flushing of the filter unit is carried out independently to a great degree from human interference and human attention, but also independently to a great degree from the operating situation of the hydraulic plant. Rather is the pressure differential more crucial, that on the one hand represents a basic statement regarding the degree of soiling of the filter column and on the other is also an essential criterion for the strength of the individual filter unit and consequently of the safety of the plant.

Moreover, another embodiment provides that a state or operational parameter recorded by the measuring instrument is a pressure or pressure differential on an individual filter unit, wherein a specified limit state or operational parameter is stored in a memory, and wherein the flushing cycle is started when the limit state or operational parameter is exceeded. The mode of operation according to this embodiment has an advantage that high operating pressures or pressure differentials will be prevented. Consequently the danger, that by blocking an individual filter unit or individual groups of filter units the pressure differential would increase to such an extent that filter units may become damaged, will be prevented. With the mode of operation according to this embodiment, the invention allows also a control of the filtering plant as a function of the situation on the individual filter units. For this purpose particularly the inlet pressure and/or the outlet pressure or the pressure differential between the inlet and outlet of the filter housing or the throughput or another operational parameter, representing the state of the individual filter unit, is measured on each filter unit. To measure the flow-through a pressure regulator, on which the pressure drop is registered, can be provided after each individual filter unit. A mode of operation of this kind, harmonised with the individual filter unit and its state, is to be preferred for highly stressed filter columns, i.e. such, which at maximum continuous throughput are exposed to high operating pressures also on the outlet side. By virtue of this long operating periods can be achieved with a narrow tolerance between the admissible and the actual pressures or pressure differentials in the filter units.

### BRIEF DESCRIPTION OF THE DRAWINGS

Having thus described the invention in general terms, reference will now be made to the accompanying drawings, which are not necessarily drawn to scale, and wherein:

FIG. 1: shows one embodiment of the present invention for operating a flushable column for a liquid; and

FIG. 2: shows another embodiment of the present invention for operating a flushable column for a liquid.

### DETAILED DESCRIPTION OF THE INVENTION

The present invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements. Like numbers refer to like elements throughout.

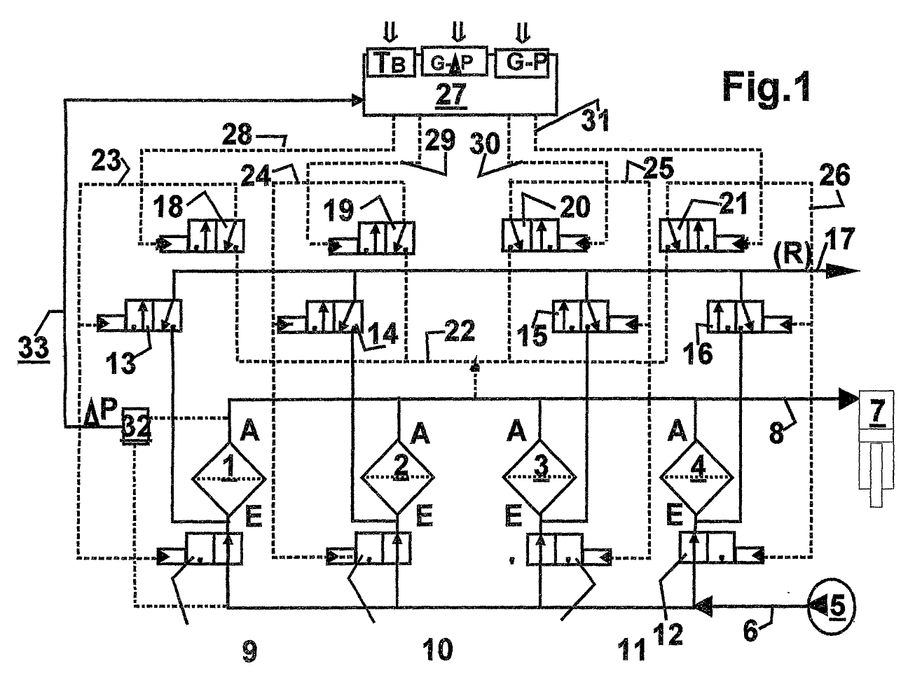

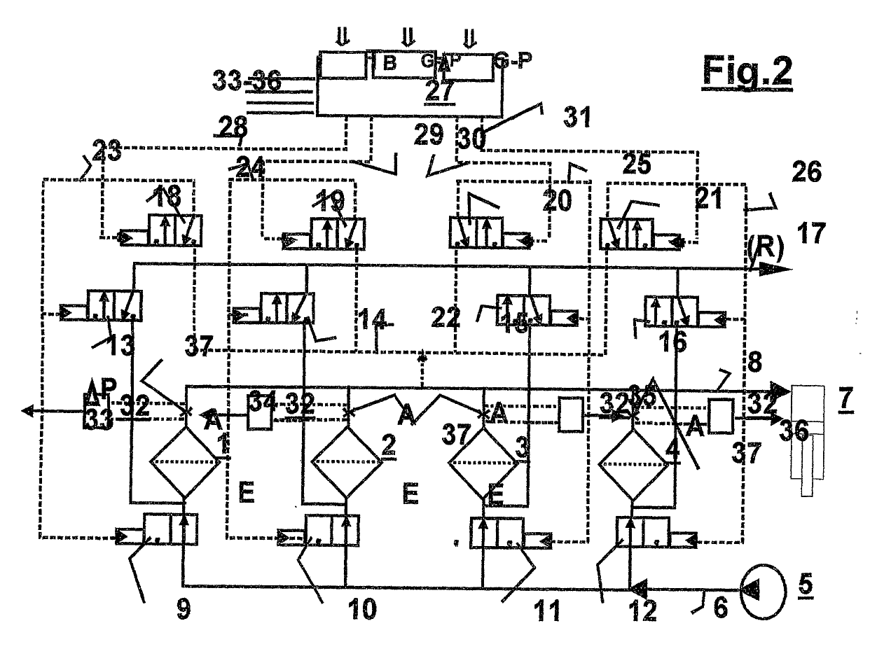

With reference to FIGS. 1 and 2, a filter column with the individual filter units 1, 2, 3, 4 is connected parallel between the inlet line 6 coming from a pumping plant 5 and the outlet line 8 leading to the hydraulic consumers 7. These filter units are only schematically shown here. As filter element each unit has, especially for the purpose of making a high flow-through possible, a hollow-cylindrical filter cartridge, the jacket surfaces of which are flown through from the outside to the inside in the filtering mode and from the inside to the outside in the reverse flushing mode. The filter cylinder comprises a suitable filter material and therefore has only reduced mechanical load-bearing capacity against the pressure differential acting on it. To absorb the forces arising due to the pressure differential on the cylindrical filter cartridge, each filter cartridge is supported on the outflow side, therefore normally on the inside, by a load-bearing, yet perforated or porous support cylinder. Due to the perforation or porosity the load-bearing capacity of such a support cylinder is, however, limited.

For this reason the filter units can be individually, as in the embodiments, or together in groups, blocked by one of the stop valves 9, 10, 11, 12, so that the flow-through of the respective filter unit from the inlet line 6 to the outlet line 8 will be blocked. The operating situation, shown in the figures, is that in which the flow-through is opened to all filter units.

Furthermore, to each of the filter units 1, 2, 3, 4 a reverse flush valve 13, 14, 15, 16 is assigned. The inlet side E of each filter unit is connected via these reverse flush valve to the reverse flush line 17 of the hydraulic plant, or, in the illustrated position of the reverse flush valves 13, 14, 15, 16, is blocked.

Each stop valve 9-12 and reverse flush valve 13-16 has a hydraulically operated pilot device, which, when acted upon by pressure, synchronously switch the stop valves 9-12 and the reverse flush valves 13-16 mentioned to their respective other switched position, namely the stop valves to their blocking position, the reverse flush valves to their reverse flush position.

The control valves 18, 19, 20, 21, of which one each is allocated to one of the filter units 1-4 and control the connection of the control pressure line 22 common for the filter column with the trigger lines 23, 24, 25, 26, which are allocated to the respective filter unit, serve the purpose of hydraulically triggering the pilot device of the valves mentioned above. The central pressure line 22 is connected to the outlet line 8 of the filter column, so that the consumer pressure will act on the trigger lines 23, 24, 25, 26 as control pressure. The control valves 18, 19, 20, 21 are magnetically controlled two-two-directional control valves. In the neutral position shown the control valves 18-21 block the respective trigger line from the control pressure line 22. In the other respective position of the control valves 18-21 the control pressure line 22 is connected with the trigger lines 23, 24, 25, 26, which lead from the respective control valve 18-21 to the hydraulic triggerings of the stop valves 9-12 as well as of the reverse flush valves 13-16, that are allocated to the respective filter unit. One control valve each 18-21 is allocated to one of the filter units 1-4. The control valves can be triggered and switched independently from one another.

For this purpose the control valves 18-21 are triggered by an electronic control device 27. In this case one deals with a microprocessor with devices for data input (manually or electronically), for data storage, for data processing, in particular for comparing data and for issuing control commands to the individual electromagnets of the control valves 18-21 via the command lines 28, 29, 30, 31. However, via an appropriate equipment (not illustrated) it can be directly entered by hand that a reverse flushing of a certain group of filter units or of all filter units in succession should be carried out.

In particular the allowable limit values, like the allowable operating time T_{B}, the allowable pressure differential G-ΔP, the allowable pressure G-P before and/or after the filter unit as well as other operational parameters, e.g. the minimum flow-through on each filter unit or group or filter column can be entered manually in the control device 27. These parameters are stored in the memory of the control device 27. Furthermore, measuring instruments, sensors for one or several of the parameters mentioned as well as measuring line 33 are allocated to the control device 27, by means of which the respective actual values (measured signals) are actually measured and can be entered in the electronic control device 27. When by using data comparison it is determined in the control device 27 that one or more of the measured actual values have reached the corresponding specified limit value, the electronic control value 27 via the command lines 28-31 issues to one of the control valve 18-21 the control commands to switch over the respective group of filter units to reverse flow or the other way around.

This is explained based on a specified regular operating period:

The limit value for the regular operating time T_{B} of the entire filter column is specified and stored in the electronic control device 27. When by means of the time measuring device of the control device 27 it is established that this limit value had been reached, the control device 27 issues a command to cease the illustrated operational setting of the filter column with the filter units 1, 2, 3, 4 by that the filter unit 1-4 will be closed in succession and reverse flushed, in other words the flushing cycle commences. It commences with the reverse flushing of filter unit 1. For this purpose first a command signal is issued to the control valve 18 via the command line 28. As a result of this control valve 18 switches to its second switched position, in which position the trigger line 23 is charged by the control pressure 22. Due to this the reverse flush valve 13 and the stop valve 9 synchronously assume their second switched position. In the second switched position the stop valve 9 blocks the inflow from the line 6 to the filter unit 1. In its second switched position the reverse flush valve 13 opens the inlet E of the filter 1 to the reverse flush line 17, to which all reverse flush valves are connected. The reverse flush line 17 is connected to devices (not illustrated) for the cleaning and preparation of the liquid, what is not subject matter of this application. Due to this connection in the sense of flushing a pressure drop occurs on the filter unit 1 and a flow-through in the reverse direction from the outlet line 8 to the reverse flush line 17, the filter units which are still in the filtering flow are supplied, as previously, with pressurised liquid under consumer pressure. The filter unit is flushed by virtue of this reverse flow-through and the dirt particles move to the reverse line. A repeated cleaning of the hydraulic fluid may be carried out here. After a specified flushing period the outlet command 28 of the electronic control 27 drops off again. Due to this the control valve 18 switches back to its initial position and the command line 23 is connected with the reverse flush line 17 and is switched to no pressure, so that the stop valve 9 and the flush valve 13 will return to their blocking positions. Consequently the filter unit 1 returns to the filtering operation.

The switching command is now issued via the electronic control 27 to the control valve 19 via the command cable 29 and the same flushing process is carried out for filter unit 2 by switching the stop valve 10 and the reverse flush valve 14, and then for filter unit 3 and filter unit 4.

A flushing cycle is thus completed. The electronic control device determines this time of the commencement of the normal operation and recommences the registration of the operating time. The electronic control is so set up, that the normal operation of the filter column is retained for the set operating time T_{B}.

FIG. 1 illustrates that instead of or in addition to this time control a control, that depends on the pressure differential of the entire filter column between the inlet side E and the outlet side A of the filter column, i.e. between the inlet line 6 and the outlet line 8, is also carried out. For this purpose the pressure in the line 8 and the pressure in the inlet line 6 is recorded by a measuring instrument 32, in this case a pressure sensor 32, and from this the pressure differential signal is generated that is passed on via the measuring line 33 to the electronic control device 27.

By means of the module G-ΔP a limit value for this pressure differential ΔP is entered in the electronic control device. When this limit value is exceeded, the flushing cycle of all filter units is started up with the flushing for the individual filter units 1-4 of the filter columns, as described above. For this purpose the pressure differential ΔP or the limit value of the pressure differential G-ΔP can be set low, so that a flushing will take place before the set operating time T_{B} expires. Such a mode of operation is recommended when the hydraulic plant operates during an essential portion of the operating time with a relatively low throughput, so that only a relatively low pressure drop occurs on the filter column. The superimposing of the reverse flush control by the operating time ensures that the reverse flushing cycle will be carried out in any case after a reasonable operating time (even when the limit value of the pressure differential is not reached).

The pressure differential ΔP or the limit value of the pressure differential G-ΔP can be also set high, so that regular flushing will be carried out when the operating time T_{B} set expires. Only in an exceptional case, e.g. due to interruptions in the operation when the pressure differential exceeds the specified limit value, will the flushing cycle be carried out before the expiry of the specified operating time. Such a method is recommended when the hydraulic plant is normally not susceptible to soiling and the limiting of the pressure differential serves only the purpose of safety.

However, the control of the reverse flushing by the operating time can be dispensed with, especially when further operational parameters are also available by specifying limit values and actual measuring.

FIG. 2 illustrates that the reverse flushing is carried out depending on an operational parameter measured on each filter unit (or group of filter units that can be controlled together). For this purpose a measuring device 32 is allocated to each filter unit. In doing so one may deal, for example, with a sensor for the flow rate per unit of time, the flow rate being measured on each filter unit or filter group by the pressure drop occurring on a throttle 37 and is specified via the measuring cables 33, 34, 35, 36 of the electronic control device 27 and allocated to the respective filter unit 1-4. As limit value the minimum value of the flow rate is entered and stored in the electronic control device 27. When one of the measured values falls short of this limit value, the reverse flushing can be carried out on the respective filter unit.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method to operate a flushable filter column including several filter units for a liquid, said method comprising:
conveying the liquid to be filtered through the filter units in a forward direction in a filtering flow; and
depending on the state or operational parameters of the filter units, which represent the state of soiling of the filter units recorded by a measuring instrument, conveying the liquid through the individual filter units in reverse in a reverse flushing flow,
wherein depending on the state or operational parameter recorded by the measuring instrument, a flushing cycle is started wherein each filter unit is blocked and reverse flushed in succession.

2. The method according to claim 1, wherein a state or operational parameter recorded by the measuring instrument is the filtering operating time of the filter units, wherein a specification of a filtering operating time of the filter units is stored in a memory, and wherein when the specified filtering operating time expires the flushing cycle is started.

3. The method according to claim 1, wherein a state or operational parameter recorded by the measuring instrument is the pressure before or after the filter column, wherein at least one of a specified upper pressure limit before the filter column or a lower pressure limit after the filter column is stored in a memory, and wherein the flushing cycle is started when the specified upper pressure limit is exceeded or the pressure drops below the specified lower pressure limit.

4. The method according to claim 1, wherein a state or operational parameter recorded by the measuring instrument is the pressure differential on the filter column, wherein a specified limit pressure differential is stored in a memory, and wherein the flushing cycle is started when the limit pressure differential is exceeded.

5. The method according to claim 1, wherein a state or operational parameter recorded by the measuring instrument is a pressure or pressure differential on an individual filter unit, wherein a specified limit state or operational parameter is stored in a memory, and wherein the flushing cycle is started when the limit state or operational parameter is exceeded.

6. The method according to claim 1, wherein all filter units are blocked from an inlet line when the pressure differential on the filter column is above a specified upper pressure differential limit.
